(19) United States
(12) Patent Application Publication
(10) Pub. No.: US 2018/0129247 A1
(43) Pub. Date: May 10, 2018

(54) CRADLE FOR A HANDHELD DEVICE, AND A SET COMPRISING CRADLES

(71) Applicant: Opticon Sensors Europe B.V., Hoofddorp (NL)

(72) Inventor: Yigit Inanc, Hoofddorp (NL)

(21) Appl. No.: 15/566,952

(22) PCT Filed: Apr. 15, 2016
(86) PCT No.: PCT/NL2016/050268

§ 371 Date: Oct. 16, 2017

(30) Foreign Application Priority Data
Apr. 15, 2015 (NL) 2014643

(51) Int. Cl. G06F 1/16; G06F 1/28; G06F 1/26; H02J 7/00

(52) U.S. Cl. CPC G06F 1/1632; G06F 1/28; H02J 2007/0062; H02J 7/0027; G06F 1/266

(57) ABSTRACT

Disclosed is a cradle for a handheld device, e.g. a handheld scanner. The cradle can for instance be a charging station and includes a device connector for connecting a handheld device to the cradle. The cradle also includes a power inlet connected and/or connectable to a power outlet of a first corresponding cradle, such as a charging station, for a handheld device, e.g. a handheld scanner. Further, the cradle includes a power outlet connected and/or connectable to a power inlet of a second corresponding cradle, such as a charging station, for a handheld device, e.g. a handheld scanner. Furthermore, the cradle is provided with an electronic monitoring circuit. The circuit can be for monitoring whether the cradle is supplied with sufficient power by the first corresponding cradle connected to the inlet of the cradle.

The invention relates to a cradle for a handheld device. The cradle can for instance be or form a charging station for the handheld device and/or arranged for facilitating data communication with the handheld device.

A known cradle for a handheld device comprises a single holder for receiving and holding a single handheld device. The holder is provided with a device connector for at least electrically connecting the handheld device to the cradle, such that the handheld device can be charged by means of the cradle, e.g. by charging a battery comprised in the handheld device. In order to provide the battery of the handheld device with charging power, the cradle comprises a power inlet connectable or connected to a power source. The power source can for instance be the electric mains. The inlet can be connected by means of a power cable, for instance via a power supply such as an electric power converter.

When multiple similar handheld devices are used at a certain place, e.g. in an enterprise, shop, supermarket, hospital, school, etc., multiple cradles may be needed for holding multiple handheld devices, e.g. during charging their batteries, updating their software, and/or reading out their memories, because charging and or syncing a handheld device may take a considerable amount of time. As a result, at a location where relatively many handheld devices are to be charged or synced, at least partly at the same time, all the cradles together may occupy more space than is desired at that place. Also, there may not be enough mains outlet sockets available, e.g. to plug in the power cables of all cradles or—for instance when the cradles are provided with a separate power converter—all power cables of all electric power converters associated with all cradles to charged and/or synced.

It is an object of the invention to provide an alternative cradle, preferably a cradle wherein at least one disadvantage of conventional cradles for handheld devices is alleviated or counteracted.

Thereto, the invention provides for a cradle for a handheld device, comprising a device connector for connecting a handheld device to the cradle; a power inlet connected and/or connectable to a power outlet of a first corresponding cradle for a handheld device; a power outlet connected and/or connectable to a power inlet of a second corresponding cradle for a handheld device; and an electronic monitoring circuit for monitoring whether the cradle is or is to be supplied with sufficient power by the first corresponding cradle connected to the inlet of the cradle and/or for monitoring whether the cradle can supply sufficient electric power to the second corresponding cradle connected and/or connectable to the power outlet of the cradle.

By providing the cradle with a power outlet, the cradle can supply a corresponding further cradle with electric power. By providing the cradle with a power inlet connectable to a power outlet of a corresponding cradle, the cradle can be supplied with electric power by another cradle. As a result, multiple cradles can be electrically interconnected to each other. Hence, the cradles do thus not need to be plugged in to their own mains outlet socket. Consequently, less mains outlet socket may be needed, due to which less space may be needed. Moreover, since preferably only a first one of multiple electrically interconnected cradles will be attached with its power inlet to a power converter or a so-called adapter, less of such power converters are needed, which may for example save a considerable amount of space, if it was only space needed for the cables, let alone space needed for any actual transformers or rechargers. Besides, less power converters may save a considerable amount material, money and/or work, e.g. in case when all cradles need to be disconnected from the power mans.

By providing the cradle with said electronic monitoring circuit, the cradle can be arranged for counteracting or preventing electric overloads. This may for instance prevent or counteract damaged equipment, such as damaged cradles or damaged handheld devices, and may even counteract or prevent fires.

Preferably, the cradle, especially its electronic monitoring circuit, can be arranged for generating a signal based on its monitoring action.

For example, the cradle comprises a feedback device or a so-called indicator for providing a user of the cradle(s) with feedback based on the signal based on the monitoring action. For instance, the cradle can be arranged for producing a warning light and/or warning tone when too much cradles are electrically connected too each other, and/or when too much electric power is consumed by the connected cradles together. Alternatively or additionally, a first cradle may be provided with a power switch which is arranged for cutting off a power supply to the device connector of said first cradle and/or a power supply to the cradle connected to the power outlet of said first cradle when too many cradles are connected and/or when the joint power consumption of the interconnected cradles is too high or is likely to become too high.

The invention also relates to a set comprising multiple interconnectable cradles, such as interconnectable charging stations. Preferably, said set can comprise one or more coupler devices, or a so-called cradle couplers, each for interconnecting a power outlet of a respective cradle with the power inlet of a further cradle.

Advantageous embodiments according to the invention are described in the appended claims.

By way of non-limiting examples only, embodiments of the present invention will now be described with reference to the accompanying figures in which:

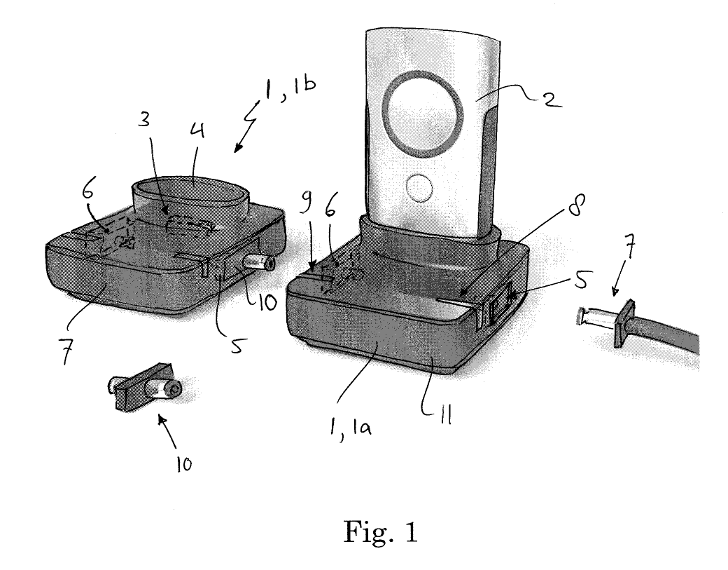

FIG. 1 shows a schematic perspective view of two corresponding cradles according to an aspect of the invention; and

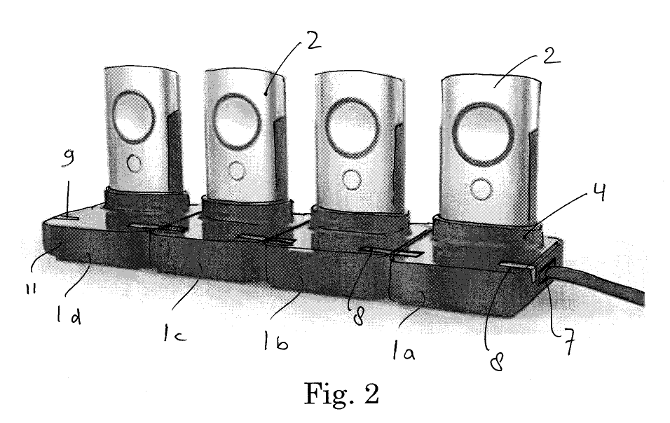

FIG. 2 shows a schematic perspective view of a set of four interconnected cradles according to a further aspect of the invention.

It is noted that the figures show merely preferred embodiments according to the invention. In the figures, the same or corresponding reference numbers refer to equal or corresponding parts.

FIG. 1 shows a schematic perspective view of two corresponding, interconnectable, cradles according to an aspect of the invention. The cradles 1 can each be arranged for a handheld device 2. Here, one of the cradles 1 is actually holding a handheld device 2. Further, FIG. 1 shows a loose coupler 10 for electrically coupling two cradles 1, a further coupler 10 plugged into a power inlet 5 of one of the cradles 1, and also a loose proximal end portion 7 of a cable for providing a cradle 1 with electric power.

As noted, the cradle 1 is for a handheld device 2. For example, the handheld device can be a wireless device and/or a handheld scanner, for instance be a handheld barcode scanner. The handheld device 2 may for instance comprise one or more buttons 12, scanning sensors, or other input means, e.g. a touchscreen, and/or screen or other output means. Further, the handheld device 2 may comprise one or more batteries facilitating the handheld device 2 to function during use. It is further noted that the cradle 1 can for instance be a charging station or a so-called charger for charging the handheld device 2, especially its battery. Preferably, the cradle may comprise a built-in charging circuit to charge a battery of the handheld device 2. Additionally or alternatively, the cradle 1 can be a docking station, dock, or so-called feeder dock, and may be arranged for syncing the handheld device 2 and/or for reading out a memory of the handheld device 2, when said handheld device 2 is connected to the cradle 1.

Furthermore, the cradle 1 comprises a device connector 3 for connecting a handheld device 2 to the cradle 1. Said device connector 3, shown in FIG. 1 by means of a dotted line, may for instance comprise and/or be formed as a plug for plugging into a corresponding connector socket of the handheld device 2.

In preferred embodiments, the cradle 1 can comprises a holder 4 for receiving and holding the handheld device 2. More preferably, the devise connector 3 may be provided at a bottom portion of said holder 4, e.g. in order to plug it into a corresponding connector provided at a bottom portion of the handheld device 2.

As can be seen best at the cradle 1 shown a the right side of FIG. 1, the cradle 1 comprises a power inlet 5. Said power inlet 5 is connectable to a power outlet 6 of a corresponding cradle, e.g. by means of a device coupler 10. Further, the cradle 1 comprises a power outlet 6 connectable to a power inlet 5 of a corresponding cradle 1, e.g. by means of a respective device coupler 10. Hence, multiple cradles 1a, 1b, 1c, 1d can be interconnected electrically, as shown in the exemplary embodiment of FIG. 2.

For example, the power inlet 5 and/or the power outlet 6 is comprised in and/or formed by means of a port and/or a socket 5, 6. In embodiments, the respective other one of the power outlet 6 and power inlet 5 may be formed by means of a plug corresponding with said socket. In preferred embodiments, both the power inlet 5 and the power outlet 6 are formed by means of a socket and are interconnectable by means of a corresponding coupler device 10 for coupling a power inlet 6 of one 1b of the cradles with a power outlet 6 of another one 1a of the cradles 1.

Further, the cradle 1 comprises an electronic monitoring circuit. Said circuit is not shown in the figures and can for instance be housed in a housing 11 of the cradle 1. The electronic monitoring circuit is for monitoring whether the cradle 1b is or can be supplied with sufficient power by a corresponding cradle 1a connected to the inlet 5 of the cradle 1b and/or for monitoring whether the cradle 1b itself can supply sufficient electric power to a corresponding cradle 1c connected and/or connectable to the power outlet 6 of said cradle 1b itself.

When too many cradles 1 would be interconnected and/or too many of said cradles would be consuming too much electric power, e.g. during charging of handheld devices, too high electric currents could flow.

For instance, too high currents could flow through a power supply, e.g. the electric power converter 7, which power supply is supplying power to the cradles and/or through one or more of the cradles, especially through one or more of the cradles 1a, 1b located at a beginning of a strain of interconnected cradles, i.e. one or more of the cradles 1a, 1b relatively close to the power supply 7, e.g. the electric power converter 7. Therefore, a, and preferably each, cradle 1 can be arranged to counteract or prevent electric overload of the cradle 1 and/or the handheld device 2 connected thereto.

Preferably, each cradle 1, especially its electronic monitoring circuit, can be arranged for generating a signal based on its monitoring action. For example, the respective cradle 1c, e.g. its monitoring circuit, can be arranged for generating a signal, e.g. a warning signal, when is monitored that said cradle 1c itself is not supplied with enough power by an adjacent corresponding cradle 1b supplying said cradle 1c with electric power and/or when is monitored that the cradle 1c itself cannot supply enough power to a second corresponding cradle 1d connected to said cradle 1c in order to receive electric power from said cradle 1c. For instance in this way, the cradle 1 can be arranged to provide a signal that the situation might be not safe and/or is not safe.

Additionally or alternatively, the cradle 1c, e.g. its monitoring circuit, can be arranged for generating a signal, e.g. a confirmation or clearance signal, when is monitored that the cradle 1c is supplied with enough power by a first corresponding cradle 1b providing it 1c with electric power and/or when is monitored that the cradle itself 1c can supply enough power to a second corresponding cradle 1d which it 1c is providing with electric power. For instance in this way, the cradle 1 can be arranged to provide a signal that the situation seems to be safe and/or is safe.

In embodiments, the cradle 1, e.g. its electronic monitoring circuit, can be arranged for monitoring a current intensity. For example, it can monitor a current intensity of a current in said cradle 1.

It is noted that when too many cradles 1b-1d are connected to a first cradle 1a, and/or when too many cradles 1b-1d connected to the first cradle 1a are working simultaneously at a relatively high load, the current flowing through the first cradle can be or become too high. When a monitoring circuit of the first cradle 1a notices that the current flowing through said cradle 1a is too high, it can for instance provide a warning signal in order to indicate a user that something is wrong and/or unsafe. This, in order to point out to a user that he should correct the situation. Alternatively or additionally, the signal may be used to cut off automatically a certain power supply, e.g. the power supply to the device connector 3 of the first cradle 1a. Preferably, each cradle 1 has its own monitoring circuit, such that for instance a second cradle 1b can check for example whether or not the current through said second cradle 1b meets the predetermined load standards.

Alternatively or additionally, the monitoring circuit can be arranged for monitoring a voltage or terminal voltage, e.g. a voltage applied to the inlet 5 of said cradle 1.

It is noted that, e.g. when too much cradles are interconnected and/or too much power is consumed by the interconnected cradles, e.g. when all or too much of the interconnected cradles are working simultaneous at a relatively high load, e.g. during charging of handheld devices, in embodiments, the voltage on an inlet 5 of one 1d or more cradles 1 at an end of a string 1a-1d of interconnected cradles 1 can be or become relatively low with respect to the voltage on an outlet 7 of a power supply, e.g. an outlet 7 of an electric power converter, which can be connected with a power inlet 5 of a first cradle 1a in said string of interconnected cradles. For example, when a certain voltage drop is monitored and/or when the voltage is below a predetermined threshold voltage, the monitoring circuit may generate a certain signal, e.g. a signal to switch off the respective cradle 1c, 1d at the end of the string at least partly.

In alternative embodiments, the electronic monitoring circuit may be arranged for monitoring data signals provided by other cradles 1. Hence, said circuit can monitor whether the respective cradle is to be supplied with sufficient power by an adjacent cradle supplying said respective cradle with electric power. For example, a first cradle 1a can provide for a first signal and a second cradle 1b can add a second signal and/or can adjust the first signal. A third cradle 1c can subsequently add a third signal and/or can further adjust the first signal, and so on. An electronic monitoring circuit of a respective further cradle 1d, preferably the respective monitoring circuit of each cradle, can then for instance be arranged for monitoring whether or not a predetermined maximum number of cradles is already present before said respective cradle 1d, such as to monitor whether it 1d is to be supplied by sufficient power by its preceding adjacent cradle 1c. It is noted that a monitoring circuit may thus be arranged to check whether or not too many cradles 1 are interconnected. However, alternatively or additionally, the monitoring circuit may be arranged for checking whether or not too much cradles are each using a relatively high amount of power, e.g. when said cradles are arranged for sending out signals informing and/or alerting the monitoring circuits of other cradles that they are using relatively much power, e.g. during charging of a respective handheld device 2. Hence, when relatively a lot of cradles are interconnected, which are for instance not all holding and/or charging a respective handheld device, the monitoring circuit may give no warning signal and/or may give a clearance signal, but when many handheld devices are subsequently connected to said cradles which will then may tend to start using a relatively high amount of power, said monitoring circuit may then stop providing a clearance signal and/or may provide a warning signal and/or a control signal, e.g. for cutting off a respective power supply.

As mentioned above, the cradle 1 may in embodiments comprise a feedback device 8 or indicator 8 for providing a user of the cradle 1 with feedback based on the signal based on the monitoring action. For example, the feedback may be regarding whether or not the respective cradle 1b is supplied with or is to be supplied with sufficient power by a first corresponding cradle 1a connected to the inlet 5 of said cradle 1b. Alternatively or additionally, the feedback can be regarding whether or not the cradle 1b can supply sufficient electric power to a second corresponding cradle 1c connected and/or connectable to the power outlet of the cradle 1b.

Preferably, the signal may comprises a warning signal for controlling the indicator 8 or the so-called feedback device 8. In embodiments, the indicator 8 or feedback device can be or comprise a warning device for providing warning feedback to the user. For example, the warning device can be arranged for producing a warning light and/or warning tone, indicating to the user that he has to disconnect one or more of the cradles 1d, 1c, e.g. cradles at the end of the string, and/or has to disconnect one or more of the handheld devices 2 from their respective cradles.

Additionally or alternatively, the indicator 8 or feedback device 8 can be or comprise a so-called clearance or confirmation device for providing clearance or confirmation feedback to the user. In embodiments, the confirmation device can be arranged for producing a confirmation or clearance light, for instance for indicating that the cradle 1a is supplied with enough power, e.g. enough power to perform operating functions such as for example charging a handheld device 2 connected to the device connector 3 of the cradle 1a, and/or enough power to supply a corresponding cradle 1b connected to said cradle 1a with sufficient electric power.

In the embodiments shown in the figures, the indicator 8 of the cradle 1 comprises one or more light sources for producing a green light when the monitoring circuit of the respective cradle 1 provides a confirmation signal when the monitored voltage and/or current does not exceed a predetermined threshold value and for producing a red light when the monitoring circuit of said cradle provides a warning signal when the measured voltage and/or current exceeds a predetermined threshold value.

Additionally or alternatively, the signal provided by the monitoring circuit may comprise a control signal for controlling a power switch. Preferably, said power switch can be comprised in the cradle 1 and is arranged for cutting off a power supply to the device connector 3 of said cradle 1. Alternatively or additionally, the power switch can be a switch comprised in the cradle 1 and can be arranged for cutting off a power supply to the power outlet 6 of the cradle.

Alternatively, the power switch can be a switch comprised in a corresponding cradle 1c, 1d connected directly and/or indirectly, e.g. via a corresponding cradle 1c, with the cradle 1b. The switch in said connected corresponding cradle 1c, 1d can be arranged for cutting off a power supply to a power outlet and/or a device connector of said corresponding connected cradle. For example, when a cradle 1a located near the beginning of a string of interconnected cradles provides a signal that the current through said cradle 1a is too high, said signal may be transferred to another cradle 1d, e.g. a cradle at or near the end of said string. In order to facilitate that a monitoring circuit of a first cradle 1a, 1b can correspond with another cradle 1c, 1d, the cradles can be arranged for communicating with each other. For example, the cradles can be arranged to send signals via the power supply of their interconnected power inlet and power outlet, e.g. indirectly via one or more intermediate cradles 1b, 1c. Alternatively, or additionally, the cradles 1 can be provided with alternative or additional communicating means, e.g. wireless communication means and/or data wires, which may be interconnectable by means of ports 5, 6 which ports, in embodiments, can also comprise the respective power inlets 5 and power outlets 6. Using a combined data and power port can be advantageously, because it may then be counteracted that a user does connect two power port without connecting corresponding data ports of the same cradles.

It is noted that the power inlet 5 and/or the power outlet 6 can thus be comprised in a port arranged for data communication and arranged for power supply. As mentioned above, the data communication can comprise a signal from a monitoring circuit. Alternatively or additionally, the data communication may comprise additional or alternative signals. For example, the data communication may be arranged for and/or may be intended for syncing handheld devices with each other and/or with one or more computer systems. For instance, the socket and/or port can be formed by a standard connector arranged for data communication and for electric power supply, such as a micro-USB connector, a mini-USB socket or a conventional USB socket. However, alternative connectors can be used in alternative embodiments. Moreover, the socket and/or port can be formed by a port mainly for electric connection, such as for instance a DC jack 5 for plugging in a power adapter and/or a coupler device 10. It is noted that the port forming or comprising the power inlet 5 and the port forming or comprising the power outlet 6 may be of distinct design, e.g. have different dimensions or different shapes, in order to counteract that two inlets 5 or two outlets 6 are interconnected unintentionally.

The invention also relates to a set comprising multiple electrically interconnectable cradles 1 for handheld devices 2. For instance, the set may comprise at least two cradles 1, such as charging stations, each cradle 1 being for a handheld device 2, e.g. a handheld scanner, the set comprising a first cradle 1a having a first device connector 3 for connecting a handheld device 2 to the first cradle 1a, a first power inlet 5 connected and/or connectable with a power source 7, and at least one first power outlet 6, the set 1a, 1b further comprising a second cradle 1b having a second device connector 3 for connecting a handheld device 2 to the second cradle 1, a second power inlet 5 connected and/or connectable the power outlet 6 of the first cradle 1a, and an electronic monitoring circuit for monitoring whether the second cradle 1b is or can be supplied with sufficient power by the first cradle 1a and/or for monitoring whether the second cradle 1b can supply sufficient electric power to a corresponding third cradle 1c connected and/or connectable to the power outlet 6 of the second cradle.

It is noted that the first cradle 1 in a string of interconnected cradles can for instance be inseparably connected to a cable of a power supply, e.g. an outlet convertor. Additionally or alternatively, a last cradle in a string of interconnected cradles can for instance lack a power outlet 6. However, it is noted that all cradles 1 in the set may preferably be of the same or similar design. Hence, a modular system can be provided which can offer relatively much freedom to its users. It is apparent that a set can for instance also comprise a power supply, e.g. an electric power converter or a so-called adapter, which may be connectable to a power inlet 5 of the cradle 1.

Further, a set may comprise one or more coupler devices 10 for coupling a power inlet 5 of one of the cradles 1 with a power outlet 6 of another one of the cradles 1. The coupler device 10, or a so-called cradle coupler 10, can for instance be a cable, which can preferably have two connectors 15, 16, especially plugs 15, 16, for connection with the power inlet 5 and power outlet 6. Alternatively, the coupler device 10 may for instance be formed by a connector block 10, for instance a block such as is shown in FIG. 1. Additionally or alternatively, the coupler device 10, the power inlet 5, and/or the power outlet 6 of the cradle 1 can comprise a latch or equivalent mechanism for counteracting that two coupled cradles 1a, 1b will become uncoupled unintentionally, e.g. such as to counteract cutting off the power connection and/or data connection between said two coupled cradles 1.

It is noted that for the purpose of clarity and a concise description features are described herein as part of the same or separate embodiments, however, it will be appreciated that the scope of the invention may include embodiments having combinations of all or some of the features described.

Moreover, the invention is not restricted to the embodiments described herein. It will be understood that many variants are possible.

For example, the cradle 1 may comprise multiple indicators 8, 9, such as a first indicator 8 for indicating whether the cradle 1c is or can be supplied with sufficient power by the first corresponding cradle 1b connected to the inlet 5 of the cradle 1c and/or for monitoring whether the cradle 1c can supply sufficient electric power to the second corresponding cradle 1d connected and/or connectable to the power outlet of the cradle 1c, and a second indicator 9 for indicating whether the handheld 2 device is being synced, is being charged, and/or is already fully charged and/or fully synced. In alternative embodiments, such second indicator 9 may be provided on the handheld device 2 in stead of in the cradle 1.

Such and other variants will be apparent to the person skilled in the art and are considered to lie within the scope of the invention as formulated in the following claims.

1. A cradle for a handheld device, comprising:
a device connector for connecting a handheld device to the cradle;
a power inlet connected and/or connectable to a power outlet of a first corresponding cradle for a handheld device;
a power outlet connected and/or connectable to a power inlet of a second corresponding cradle for a handheld device; and
an electronic monitoring circuit for monitoring whether the cradle is or can be supplied with sufficient power by the first corresponding cradle connected to the power inlet of the cradle and/or for monitoring whether the cradle can supply sufficient electric power to the second corresponding cradle connected and/or connectable to the power outlet of the cradle.

2. The cradle according to claim 1, wherein the cradle is arranged for generating a signal based on its monitoring action.

3. The cradle according to claim 2, wherein the cradle comprises a feedback device or an indicator for providing a user of the cradle with feedback based on the signal based on the monitoring action.

4. The cradle according to claim 2, wherein the signal comprises a warning signal for controlling the indicator or the feedback device.

5. The cradle according to claim 2, wherein the signal comprises a control signal for controlling a power switch.

6. The cradle according to claim 5, wherein the power switch is comprised in the cradle and is arranged for cutting off a power supply to the device connector of said cradle.

7. The cradle according to claim 1, wherein the power inlet and/or the power outlet is comprised in and/or formed by a socket.

8. The cradle according to claim 1, wherein the power inlet and/or the power outlet is comprised in a port arranged for data communication and for power supply.

9. The cradle according to claim 7, wherein the socket is formed by a standard connector arranged for data communication and for electric power supply.

10. The cradle according to claim 1, wherein the cradle is arranged for providing electrical power to the handheld device for charging a battery of the handheld device.

11. A set of cradles, comprising at least two cradles according to claim 1.

12. A set of cradles, comprising a plurality of electrically interconnectable cradles for handheld devices.

13. A set of cradle comprising at least two cradles, each cradle being for a handheld device, wherein the set of cradles comprising:
a first cradle having a first device connector for connecting a handheld device to the first cradle;
a first power inlet connected and/or connectable with a power source; and
at least one first power outlet,
wherein the set of cradles further comprising:
a second cradle having a second device connector for connecting a handheld device to the second cradle;
a second power inlet connected and/or connectable the power outlet of the first cradle; and
an electronic monitoring circuit for monitoring whether the second cradle is supplied or can be supplied with sufficient power by the first cradle and/or for monitoring whether the second cradle can supply sufficient electric power to a corresponding third cradle connected and/or connectable to the power outlet of the second cradle.

14. The set of cradles according to claim 11, further comprising at least one coupler device for coupling the power inlet of one of the cradles with power outlet of another one of the cradles.

15. The set of cradles according to claim 11, wherein the power inlet of one of the cradles is connected to the power outlet of another one of the cradles.

16. The cradle according to claim 2, wherein the electronic monitoring circuit of the cradle is arranged for generating the signal.

17. The cradle according to claim 8, wherein the port is formed by a standard connector arranged for data communication and for electric power supply.

18. The cradle according to claim 9, wherein the standard connector is a micro-USB connector.

19. The cradle according to claim 17, wherein the standard connector is a micro-USB connector.

20. The set of cradles according to claim 15, wherein the power inlet of one of the cradles is connected to the power outlet of another one of the cradles by a coupler device.
